(19) United States
(12) Patent Application Publication
(10) Pub. No.: US 2016/0354978 A1
(43) Pub. Date: Dec. 8, 2016

(54) COMPOSITION AND METHOD FOR THREE-DIMENSIONAL (3D) PRINTING

(71) Applicants: Arie KALO, Ness Ziona (IL); Gabby SARUSI, Rishon Le-Zion (IL); Nir GILBOA, Kfar Ha Nagid (IL); Shahar KALO, Ness Ziona (IL)

(72) Inventor: Arie Kalo, Ness Ziona (IL)

(21) Appl. No.: 15/118,076

(22) PCT Filed: Feb. 10, 2015
(86) PCT No.: PCT/IL2015/050148

§ 371 Date: Aug. 10, 2016

(30) Foreign Application Priority Data
Feb. 10, 2014 (IL) 230897

(51) Int. Cl. B29C 67/00; B33Y 70/00; F41B 13/02; B28B 1/00; F41C 3/00; F41C 7/00; B33Y 10/00; B33Y 80/00

(52) U.S. Cl. CPC B29C 67/0055; B29C 67/0088; B33Y 10/00; B33Y 70/00; B33Y 80/00; B28B 1/001; F41C 3/00; F41C 7/00; F41B 13/02; B29K 2105/0052

(57) ABSTRACT

A method for producing an X-ray detectable three-dimensional (3D) object or a part thereof using a 3D printer includes: (i) providing a composition comprising at least one 3D printing material and at least one X-ray contrast agent; (ii) providing a digital model of the object or part thereof; and (iii) printing the 3D object or part thereof from the digital model using the composition of (i), thus obtaining the X-ray detectable printed 3D object or part thereof, which can be visualized under X-ray scanning.

### FIELD OF THE INVENTION

The present invention relates in general to methods for producing three-dimensional (3D) objects using 3D printers and, in particular, to the manufacture of 3D printed weapons.

### BACKGROUND OF THE INVENTION

3D printing, also known as “additive manufacturing”, is a typically digitally-controlled process in which 3D objects of any shape are produced, using computerized 3D models, by laying down successive thin layers of printing material one on top of the other according to the 3D model. Each layer can be of a thickness of less than a millimeter such as between 10-100 micrometers (□m). A known measuring unit for 3D printers' resolution is dots per inch (DPI) wherein 100 micrometers is equivalent to 250 DPI. X-Y resolution of some 3D printers is equivalent or close to that of high-resolution 2D laser printers.

There are several additive processes known in the art that can be used with 3D printers, such as: (i) extrusion deposition process, in which small polymer beads of printing material that quickly harden are extruded to form each layer of the 3D object; (ii) granular materials binding process, in which several printing materials are selectively fused; (iii) photo-solidification or photopolymerization process using stereolithography, in which optical means are used to solidify the liquid polymeric layers that are printed; and (iv) stereolithography, based on optical masking, in which the 3D model is virtually sliced by a set of horizontal planes, each converted into a 2D mask image that is projected onto a photocurable liquid resin surface, having its shape cured by light projected thereover.

The 3D printing technology is used for prototyping and manufacturing with applications in various fields such as architecture, military, construction, automotive, aerospace, dental and medical industries and many others.

In recent years, 3D printers have become widely available and are used not only by manufacturers but also by private individuals that can purchase it at relatively reasonable prices. Domestic 3D printing is being used for many purposes. On-line 3D printing services are being offered by some companies to both consumers and industries whereby an individual can upload his 3D design to the company website and the 3D product printed using industrial 3D printers is either shipped to, or picked up by, the individual.

X-ray contrast agents are contrast media that permit enhancement of X-ray based imaging and visualization of the details of organs, objects or materials that would not otherwise be demonstrable under X-ray scanning. X-ray contrast agents are mainly used for medical purposes in clinical diagnostic radiology, in which the contrast agent is administered to a patient and then subjecting the patient to medical imaging.

However, X-ray contrast agents have found further applications in other fields. For example, X-ray contrast agents can be added to materials from which surgical objects are produced such as gauze pads or to materials that can be administered to a patient body, for allowing detecting the object or other material once the patient's body is scanned via an X-ray machine. The contrast agent can then be used to discover surgical tools and pads mistakenly left in the patient's body during surgery.

WO2010/039799 discloses an article and thermoplastic composition including polycarbonate, a polysiloxane-polycarbonate and an x-ray detectable or metal detectable agent having good magnetic permeability and/or electrical conductivity, for use in articles for food preparation. The thermoplastic compositions are useful in forming molds for manufacturing a food product, such as chocolate molds.

Canadian patent application No. CA2802597 discloses extrusion and compression molding methods for making X-ray detectable, resin-based material in stock shapes such as rods and sheets. The rods and sheets may include barium sulfate in a concentration such that the structural properties of the resin are not materially altered from those of pure resin, but relatively small fragments of the material are X-ray detectable by conventional equipment, even at high line speeds.

Japanese patent applications JP2003093432 and JP2003096248 disclose an X-ray contrast ink for enabling to detect gauze pads under X-ray scanning to secure that they are not left inside the body of a patient. The contrast ink includes at least one kind of an X-ray contrast medium selected from barium sulfate, oxybismuth carbonate, sodium iodide, silver-protein colloid, silver iodide-gelatin colloid, thorium oxide (IV) sol, iodine-added unsaturated fat and oil, iodine suspended fat and oil, and iodine pyridone sodium acetate.

### SUMMARY OF THE INVENTION

The present invention relates in one aspect to a method for producing a 3D printed weapon or another object that can be detected and visualized under X-ray scanning.

In another aspect, the invention provides a composition comprising at least one 3D printing material and at least one X-ray contrast agent for use in the manufacture of X-ray detectable 3D printed weapon or another object.

### BRIEF DESCRIPTION OF THE DRAWINGS

FIG. 1 schematically illustrates a method for producing 3D objects that are detectable under X-ray scanning thereof using a 3D printer, according to some embodiments of the present invention.

### DETAILED DESCRIPTION OF THE INVENTION

The present invention, in some embodiments thereof, provides methods for producing three-dimensional (3D) objects that can be detectable under X-ray scanning, wherein the 3D objects are produced by a 3D printer.

Among the 3D products that can be designed and produced by 3D printers are 3D printed weapons such as firearms. In 2012, the U.S.-based group Defense Distributed disclosed plans to “[design] a working plastic gun that could be downloaded and reproduced by anybody with a 3D printer.” The group has also designed a 3D printable AR-15 type rifle lower receiver (capable of lasting more than 650 rounds) and a 30 round M16 magazine. Soon after Defense Distributed succeeded in designing the first working blueprint to produce a plastic gun with a 3D printer in May 2013, the United States Department of State demanded that they remove the instructions from their website. However, exact plans for producing 3D printed firearms exist in various websites and can be freely downloaded. It seems that attempts to restrict the distribution over the internet of gun plans are futile and some US regulators have proposed regulations on 3D printers, to prevent them being used for printing guns.

In accordance with the present invention, a method is provided for producing an X-ray detectable three-dimensional (3D) weapon or a part thereof using a 3D printer, said method comprising:
(i) providing a composition comprising at least one 3D printing material and at least one X-ray contrast agent;
(ii) providing a digital model of said weapon or part thereof; and
(iii) printing said 3D weapon or part thereof from said digital model using said composition of (i), thus obtaining said X-ray detectable printed 3D weapon or part thereof that can be visualized under X-ray scanning.

In some embodiments, the weapon is a firearm such as, but not limited to, a gun, a pistol, a rifle, a carbine, a grenade launcher. In some other embodiments, the weapon is a non-firearm weapon such as, but not limited to, a knife, a sword or a mace. Also parts of the firearms or non-firearm weapons can be manufactured by the method of the invention and assembled later on to produce the desired weapon.

In another aspect, the present invention provides a method for producing an X-ray detectable three-dimensional (3D) object or a part thereof using a 3D printer, said method comprising:
(i) providing a composition comprising at least one 3D printing material and at least one X-ray contrast agent;
(ii) providing a digital model of said object or part thereof; and
(iii) printing said 3D object or part thereof from said digital model using said composition of (i), thus obtaining said X-ray detectable printed 3D object or part thereof that can be visualized under X-ray scanning.

Any desired object or part thereof can be produced by the method of the invention.

In an additional aspect, theresent invention provides a composition comprising at least one 3D printing material and at least one X-ray contrast agent, for use in the manufacture of X-ray detectable weapons or parts thereof by 3D printing technology.

In a further additional aspect, the present invention provides a composition comprising at least one 3D printing material and at least one X-ray contrast agent, for use in the manufacture of X-ray detectable objects or parts thereof by 3D printing technology.

Any material suitable for 3D printing can be used in the 3D printing composition and method of the invention including, but not limited to, thermoplastic, photopolymer, ceramic, and metal materials. In certain embodiments, the 3D printing material is a thermoplastic polymer or a photopolymer such as, but not limited to, acrylonitrile butadiene styrene (ABS) polymer and ABS-like polymers, rubber-like polymers, poly lactic acid (PLA) and PLA-like polymers, polypropylene-like polymers, a thermoplastic elastomer (TPE) also referred to as “thermoplastic rubber”, thermoplastic polyurethane (TPU), nylon (PA) composites, polycarbonate, polysiloxane-polycarbonate. In certain embodiments, the 3D printing material is a metal such as stainless steel alone or in mixture with bronze, gold, silver, or titanium. The 3D printing material in general is one that has a low or no X-ray detectability.

The 3D printing material will be selected according to the properties or characteristics of the desired 3D printed object and according to the method chosen for its 3D printing It is possible to use more than one 3D printing material to obtain layers of different materials.

The X-ray contrast agent useful in the method and composition of the invention is, in certain embodiments, an inorganic compound comprising X-ray scattering atoms having an atomic number equal to or above 22. In certain embodiments, the X-ray contrast agent is selected from inorganic pigments such as zinc oxide, titanium dioxides, iron oxides, chromium oxides, calcium carbonate, cobalt carbonate, cadmium sulfide, cerium sulfide, zinc sulfide, barium sulfate and strontium sulfate. In certain embodiments, the X-ray contrast agent is barium sulfate.

The ratio between the X-ray contrast agent and the 3D printing material in the composition of the invention shall be such that the X-ray contrast agent does not adversely affect or alter properties of the 3D printing material thus maintaining the same or similar 3D printing quality of the printing material. The addition of the X-ray contrast agent to the 3D printing material will dramatically enhance the X-ray detectability of the 3D objects printed with the composition by a 3D printer.

The ratio between the 3D printing material and the X-ray contrast agent in the composition may also depend on the X-ray detectability properties of the 3D printing material. For instance, the less the printing material is detectable under X-ray scanning the higher will be the concentration of the X-ray contrast agent in the composition.

In certain embodiments, the ratio between the weight of the X-ray contrast agent and the 3D printing material is higher than 1 percent, optionally higher than 10 percent. The ratio between the 3D printing material and the X-ray contrast agent in the composition may also depend on the X-ray detectability properties of the 3D printing material. For instance, the less the printing material is detectable under X-ray scanning the higher will be the concentration of the X-ray contrast agent in the composition.

In certain embodiments, the 3D printing material is a low viscosity or high viscosity liquid. In certain embodiments, the 3D printing material is in paste-like form. In certain other embodiments, it is in solid form, for example, in the form of powder, beads, filaments, granules, and the like. The solid form may be transformed by the 3D printer in a preliminary preparation stage to liquid for printing down the layers of the 3D objects. s a low viscosity

According to certain embodiments, the X-ray contrast agent may be selected according to the type and state of the 3D printing material to allow mixing of the two materials in the most unified manner. For example, for liquid 3D printing material, a contrast agent in the state of liquid may be used whereas in cases in which the printing material is powder the agent may also be in powder state. A well-mixed composition will ensure that the dissemination of the X-ray contrast agent in the 3D object produced by the 3D printer using this composition will be as homogeneous as possible to ensure easy detection of the contours and inner parts of the 3D objects in an X-ray scanning.

According to some embodiments, the composition is contained in a cartridge or any other suitable container of the 3D printer to be used thereby for printing 3D objects. If the 3D printer has more than one cartridge, each such cartridge will contain the composition comprising the same or different 3D printing material used for producing the 3D printed object or weapon.

Any suitable 3D printing technique can be used according to the present invention. The 3D object is created by placing layer over layer with the help of an additive material and a digital file (CAD). Technologies that can be used include photopolymer spraying technologies such as PolyJet printing, Cold Spray 3D printing technology, Stereo Lithography (SLA), Laser Sintering (LS), Electron Beam Melting (EBM), Fused Disposition Modeling (FDM), Laminated Object manufacturing (LOM), and others.

The actual 3D printing process according to the invention is the same used with a 3D printing material without X-ray contrast agent. The addition of the X-ray contrast agent to the 3D printing material does not require altering any mechanical configuration or definitions of the 3D printer. The X-ray detectable 3D objects produced by the same 3D printer will have the same properties (rigidness level, color, etc.) as a similar 3D object produced by using the same 3D printing material without the X-ray contrast agent. The only difference is that the 3D object or weapon produced using the composition of the present invention containing at least one X-ray contrast agent will be detectable and visualized under X-ray scanning.

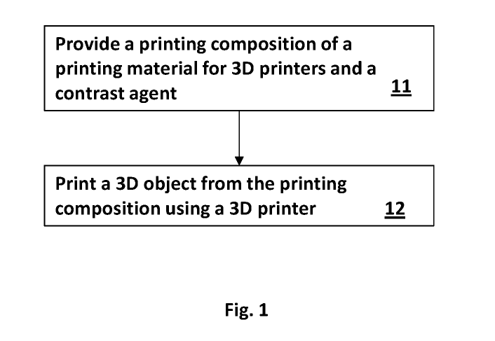

Reference is now made to FIG. 1 schematically illustrating a method for producing 3D objects that are detectable under X-ray scanning using a 3D printer, according to some embodiments of the present invention. The method includes providing a composition as a raw material for printing 3D objects using 3D printers, wherein the composition includes a 3D printing material such as a thermoplastic material and a X-ray contrast agent such as barium sulfate mixed therewith 11. The provided composition is used for producing a 3D object/weapon by a 3D printing technology using a 3D printer 12. The composition and the printing technique ensure that the printed 3D objects have a unified dissemination of the X-ray contrast agent therein and therefore can be easily detected under an X-ray scanner.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A method for producing an X-ray detectable three-dimensional (3D) weapon or a part thereof using a 3D printer, said method comprising:
providing a composition comprising at least one 3D printing material and at least one X-ray contrast agent;
providing a digital model of said weapon or part thereof; and
printing said 3D weapon or part thereof from said digital model using said composition,
thus obtaining said X-ray detectable printed 3D weapon or part thereof that can be visualized under X-ray scanning.

2. The method according to claim 1, wherein said weapon is a firearm, a knife, a sword or a mace.

3. The method according to claim 2, wherein said firearm is a gun, a pistol, or a rifle.

4. A method for producing an X-ray detectable three-dimensional (3D) object or a part thereof using a 3D printer, said method comprising:
providing a composition comprising at least one 3D printing material and at least one X-ray contrast agent;
providing a digital model of said object or part thereof; and
printing said 3D object or part thereof from said digital model using said composition, thus obtaining said X-ray detectable printed 3D object or part thereof that can be visualized under X-ray scanning.

5. The method according to claim 1, wherein the 3D printing material is any material suitable for 3D printing including a thermoplastic, a photopolymer, or a ceramic material.

6. The method according to claim 1, wherein the X-ray contrast agent is an inorganic compound comprising X-ray scattering atoms having an atomic number equal to or above 22.

7. The method according to claim 6, wherein the inorganic X-ray contrast agent is selected from inorganic pigments such as zinc oxide, titanium dioxides, iron oxides, chromium oxides, calcium carbonate, cobalt carbonate, cadmium sulfide, cerium sulfide, zinc sulfide, barium sulfate and strontium sulfate.

8. The method according to claim 1, wherein the X-ray contrast agent is barium sulfate.

9. A composition comprising at least one 3D printing material and at least one X-ray contrast agent, for use in the manufacture of X-ray detectable weapons or parts thereof by 3D printing technology.

10. A composition comprising at least one 3D printing material and at least one X-ray contrast agent, for use in the manufacture of X-ray detectable objects or parts thereof by 3D printing technology.

11. The composition according to claim 9, wherein the 3D printing material is any material suitable for 3D printing including a thermoplastic, a photopolymer, or a ceramic material.

12. The composition according to claim 9, wherein the X-ray contrast agent is an inorganic compound comprising X-ray scattering atoms having an atomic number equal to or above 22.

13. The composition according to claim 12, wherein the inorganic X-ray contrast agent is selected from inorganic pigments such as zinc oxide, titanium dioxides, iron oxides, chromium oxides, calcium carbonate, cobalt carbonate, cadmium sulfide, cerium sulfide, zinc sulfide, barium sulfate and strontium sulfate.

14. The composition according to claim 9, wherein the X-ray contrast agent is barium sulfate.

15. A 3D printed weapon or part thereof that can be visualized under X-ray scanning.
